(19) United States
(12) Patent Application Publication
(10) Pub. No.: US 2005/0128288 A1
(43) Pub. Date: Jun. 16, 2005

(54) Non-medical videoscope

(75) Inventors: Robert M. Bernstein, Culver City, CA (US); William I. Berks, Manhattan Beach, CA (US)

Correspondence Address: Daniel H. Golub, 1701 Market Street, Philadelphia, PA, 19103, US

(73) Assignee: Matech Acrospace Inc.

(21) Appl. No.: 10/921,764

(22) Filed: Aug. 19, 2004

Related U.S. Application Data
(63) Continuation-in-part of application No. 10/731,329, filed on Dec. 9, 2003.
(60) Provisional application No. 60/496,438, filed on Aug. 19, 2003.

(51) Int. Cl. H04N 7/18

(52) U.S. Cl. 348/85

(57) ABSTRACT

A videoscope includes a sensor end having an image detector and at least one sensor selected from the group consisting of an eddy current sensor, an ultrasonic sensor, or an array of such sensors, a handle; and an elongated arm that comprises a conduit that connects the sensor end to the handle. The conduit houses a link that transmits image information from the image detector through the conduit, and the conduit further houses at least first and second working channels that extend from the sensor end to the handle. Fluid injected at a handle end of the conduit passes through the first working channel, out the sensor end, and onto the surface under examination. The second working channel contains the eddy current or ultrasonic sensor and passes their signals through the conduit.

The present application is a continuation-in-part of U.S. patent application Ser. No. 10/731,329, filed Dec. 9, 2003, entitled “Non-Medical Videoscope” (incorporated herein by reference), which claims the benefit of U.S. provisional application No. 60/496,438 (also incorporated herein by reference in its entirety).

### FIELD OF THE INVENTION

The field of the invention is videoscopes.

### BACKGROUND OF THE INVENTION

A videoscope has an image detecting element (a CCD, for example) at a distal end (the “sensor end”) of an elongated arm (rigid or flexible) wherein the arm is coupled to a handle and signals from the image detecting element are transmitted from the image detecting element and along the arm towards the handle by one or more electrical conductors. The signals are subsequently transmitted to a display, and an image generated from the signals is viewed by a videoscope operator. Videoscopes will typically also comprise one or more optical fibers extending along the arm between the handle and the sensor end. Such optical fibers are used to transmit light to the sensor end and to provide light for illuminating the field of view of the image detecting element.

The principle of eddy current testing for cracks is that as a coil of wire is drawn across a crack, there is a differential current produced in the coil that is a measure of the crack size, as it interrupts the magnetic field produced by the coil. When an AC current flows in a coil in close proximity to a conducting surface the magnetic field of the coil will induce circulating (eddy) currents in that surface. The magnitude and phase of the eddy currents will affect the loading on the coil and thus its impedance. As an example, assume that there is a deep crack in the surface immediately underneath the coil. This will interrupt or reduce the eddy current flow, thus decreasing the loading on the coil and increasing its effective impedance. This is the basis of eddy current testing, by monitoring the voltage across the coil in such an arrangement changes in the material of interest may be detected.

Geometry affects eddy current sensor performance, especially where the surface being investigated is not flat. Geometrical features such as curvature, edges, grooves etc. often exist on the surface of interest exist and will effect the eddy current response. Test techniques must recognize this, for example in testing an edge for cracks the probe will normally be moved along perpendicular to the edge so that small changes may be easily seen. Where the material thickness is less than the effective depth of penetration, this will also effect the eddy current response.

Proximity between the eddy current sensor and the surface of interest is another factor that affects eddy current sensor performance. In particular, the occurrence of a “lift-off” signal as the probe is moved on and off the surface and the reduction in sensitivity that occurs as the coil to product spacing increases, both negatively affect the performance of the eddy current sensor.

When attempting to use a conventional eddy current probe to examine tubine engine blades through a videoscope or borescope, both the geometry and proximity factors discussed above negatively impact performance of the eddy current sensor: The geometry negatively affects performance because the blade geometry is not flat. With respect to lift-off, it is difficult to maintain the probe in contact with the blade as it is swept across the surface, as well as maintaining it normal to the blade surface.

What is needed is an improved videoscope having an eddy current sensor that may be used to inspect turbine blades. The improved device should be less susceptible than current systems to “lift off.” In addition, the performance degradation that occurs in existing systems upon inspection of a non-flat geometry should be minimized or eliminated in the improved device.

### SUMMARY OF THE INVENTION

The present invention is directed to an improved videoscope based inspection tool that has at least two working channels extending along the arm wherein one channel (a “sensor/tool channel”) is adapted to permit a non-destructive testing (NDT) sensor or a tool to be positioned at the distal end, and a second channel (a “fluid delivery” channel) is adapted to guide a fluid (a gas or liquid) to the sensor end. Such an inspection tool permits the use of miniature NDT probes and remediation tools in remote and normally inaccessible areas such as the internal areas of an engine, metal structures within the walls of a building, remote sections of a pipe, and the like.

Combining the working channels with an image detecting element allows an operator to view the position and/or operation of any tool passing through the sensor/tool channel as well as the placement of any fluid passing through the fluid delivery channel. In some instances any lens system used to focus a signal on the image detecting element could be directed toward where a tool passing through the working channel would be during its operation.

In one embodiment, the videoscope includes a sensor end having an image detector and at least one sensor selected from the group consisting of an eddy current sensor, an ultrasonic sensor, or an array of such sensors; a handle; and an elongated arm that comprises a conduit that connects the sensor end to the handle. The conduit houses a link that transmits image information from the image detector through the conduit, and the conduit further houses at least first and second working channels that extend from the sensor end to the handle. Fluid injected at a handle end of the conduit passes through the first working channel, out the sensor end, and onto the surface or object under examination. The second working channel contains the eddy current or ultrasonic sensor and transmits their signals through the conduit.

In another embodiment, the videoscope includes a sensor end having an image detector and an eddy current sensor that comprises a hemispherical surface and a pickup coil wrapped around the sensor. The hemispherical surface maintains contact with the surface of interest during examination of the surface of interest with the eddy current sensor. The videoscope also includes a handle, and an elongated arm having a conduit that connects the sensor end to the handle. The conduit houses a link that transmits image information from the image detector through the conduit, and at least one working channel that extends from the sensor end to the handle. The at least one working channel transmits signals from the eddy current sensor through the conduit during examination of the surface with the eddy current sensor.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a videoscope, in accordance with one embodiment of the present invention;

FIG. 2 is a diagram of the sensor end of a videoscope with a hemispherically-shaped eddy current sensor, in accordance with another embodiment of the present invention.

### DETAILED DESCRIPTION

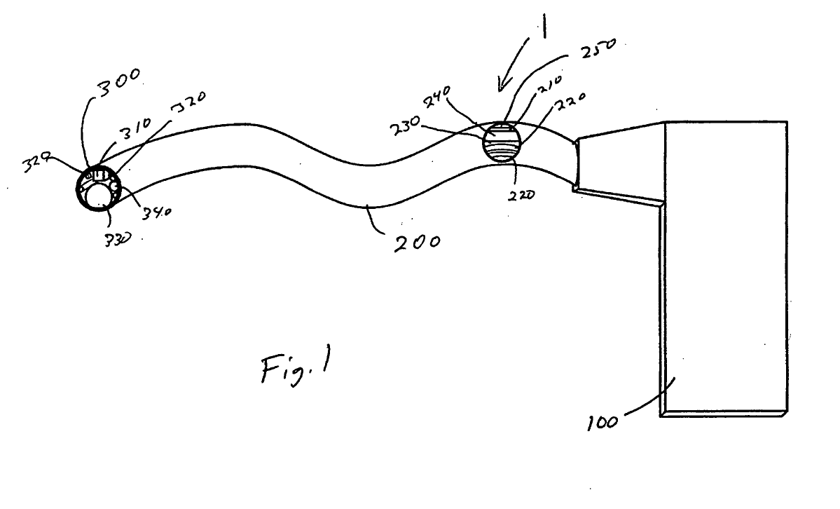

As shown in FIG. 1, a videoscope 1 comprises a handle 100 and an arm 200 wherein arm 200 comprises a sensor end 300. Sensor end 300 comprises an image detecting element 310, optical fiber ends 320, and the ends of working channels 330 and 340. Fibers 220 extend along the length of arm 200, as do working channels 230 and 240, and conductors 210. Conductors 210 transmit signals to and from element 310. Arm 200 may also comprise one or more steering cables 250 required for distal end articulation. The portion of arm 200 that is coupled to handle 100 may be referred to as the handle end, and the sensor end 300 of the arm may be referred to as the distal end.

As can be seen, FIG. 1 depicts an improved videoscope based inspection tool 1 that has at least two working channels 330 and 340 extending along the arm wherein one channel (a “sensor/tool channel”) is adapted to permit a non-destructive testing (NDT) sensor or a tool to be positioned at the distal end, and a second channel (a “fluid delivery” channel) is adapted to guide a fluid (a gas or liquid) to the sensor end. Such an inspection tool permits the use of miniature NDT probes and remediation tools in remote and normally inaccessible areas such as the internal areas of an engine, metal structures within the walls of a building, remote sections of a pipe, and the like.

It is contemplated that any tool or sensor having an appropriate size could be positioned near the sensor end using the sensor/tool channel. However, it is contemplated that eddy current sensor(s) (e.g., either a single eddy current sensor or an array of eddy current sensors), ultraviolet, and ultrasonic sensor(s) (e.g., either a single ultrasonic sensor or an array of ultrasonic sensors) may prove particularly advantageous, and can be manufactured to pass through the sensor/tool channel while maintaining an adequate signal-to-noise ratio.

It is contemplated that transmitting a fluid to the sensor end through the fluid delivery channel would be particularly advantageous if the fluid was one of: water (or other coupler) to enhance the output of an ultrasound sensor positioned via the sensor/tool channel; or a dye penetrant (or air to speed the drying of the dye penetrant) to be used with a ultraviolet (UV) light source and detector to examine the dye penetrant after it has been applied to a surface. However, any fluid that serves a desired purpose at the sensor end of the tool could be transported to that end via the fluid delivery channel. Fluid from the fluid delivery channel may also be used to mark a suspicious area (e.g., an area where a crack may be present) for further examination. In one embodiment (not shown), a syringe located on or near handle 100 is used to inject fluid through the fluid delivery channel and onto the surface being analyzed.

The actual materials used in the construction of videoscope 1 may vary between different types of videoscopes, as may the sizes and dimensions of its various components.

Arm 200 may be rigid or flexible. If flexible, it is advantageous to provide it with a steering mechanism such as cables 250 in order to be able to change the position of the sensor end 300 from handle 100. Less preferred embodiments may use a different type of steering mechanism.

The working channels, optical fibers, and conductors are preferred to be positioned within arm 200 in order to protect them and to make insertion of arm 200 into small openings easier. However, in less preferred embodiments, one or more elements of videoscope 1 that extend from the handle to a position at or near sensor end 300 may be positioned on the outside of arm 200, or may simply be adjacent to arm 200.

Image detecting element 310 is preferably a CCD (charge coupled device) detector, square or rectangular in shape, and sized to fit in an 11 or 12 mm envelope, or even a 6 to 8 mm envelope. However, element 310 may comprise and device or combination of devices suitable for detecting and transmitting images of surfaces and/or objects positioned near the sensor end of videoscope 1. In less preferred embodiments, an image may be transmitted via an optical fiber, or element 310 may be something other than a CCD.

It is contemplated that an inspection tool as described herein may comprise multiple image detecting elements. In such an instance, the use of multiple elements may be used to provide a larger field of view and/or different viewing angles. If multiple image detecting elements are used, one or more elements may be dedicated to viewing a particular portion of the tool, or to a surface being inspected and/or manipulated.

### EXAMPLE #1

It is contemplated that videoscopes having delivery channels as described herein may be used in conjunction with an ultrasound sensor being positioned through use of the videoscope. In such an instance, an ultrasound sensor could be passed through an arm of the videoscope, and the videoscope used first to identify a location where the sensor is to be positioned, then to transmit a fluid such as water to that location, and then to position the sensor. Ideally, fluid transmission, and positioning of the ultrasound sensor would all be done while using the videoscope to view the location where the sensor is being positioned.

### EXAMPLE #2

It is contemplated that videoscopes having delivery channels as described herein may also be used to mark a suspicious area for further examination. The use of a videoscope to do such marking allows objects or portions of objects that are not readily accessible to be marked, and allows them to be marked without having to stop viewing the area through the videoscope. As such, a method of using a videoscope comprising a fluid delivery channel may comprise one or more of the following steps: using a videoscope comprising a fluid delivery channel to examine an object or a portion of an object and to identify a portion of the object that is to be further examined, replaced, and/or repaired; while viewing the portion of the object to be marked through the videoscope, causing fluid to flow through an arm of the videoscope and onto or adjacent to the identified portion of the object; subsequently removing and/or disassembling the object and locating the identified portion of the object. If, for example, the object is an aircraft engine having internal assemblies that are only visible with disassembling the engine, through the use of access ports and a videoscope, one could use such a port and the videoscope to identify a potential problem within the engine, to mark that spot using fluid delivered via the videoscope, to remove the scope from the access port and thereby temporarily losing visibility to the marked portion, and then removing and/or partially disassembling the engine to regain visibility to the marked portion. In contrast, prior methods would typically require either removal and/or disassembly of the engine for inspection, and having to re-locate the area of concern after such removal and/or disassembly.

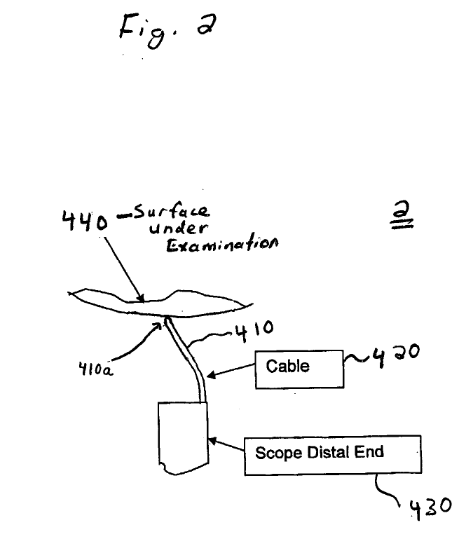

FIG. 2 is a diagram of the sensor end of a videoscope 2 with a hemispherically-shaped eddy current sensor 410, in accordance with another embodiment of the present invention. The videoscope shown in FIG. 2 is substantially the same as the videoscope shown in FIG. 1, except the videoscope in FIG. 2 includes an eddy current probe 410 which is comprised of a hemispherical surface 410a and windings (not shown) around the probe that function as a conventional pickup coil. Probe 410 is cantilevered from the end of its cable 420, reaching out of the distal end 430 of videoscope 2. The cable 420, being flexible, is fed into the working channel of videoscope 2 and observed through a video monitor until the hemispherical surface 410a of probe 410 is in contact with the surface 440 being examined (e.g., an aircraft engine blade), and then some, to bend over cable 420. Then, during examination of surface 440 with videoscope 2, as the distal end 430 is moved to traverse the probe 410 across the surface 440, the hemispherical surface 410a of probe 410 remains in contact with the surface 440 and cable 420 bends or unbends to accommodate changes in the contour of surface 440. During this process, the hemispherical surface 410a of probe 410 remains in contact with surface 440, and is normal to the surface.

Thus, specific embodiments and applications of videoscopes having fluid delivery channels have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A videoscope for examining a surface, said videoscope comprising:
(a) a sensor end having an image detector and an ultrasonic sensor array;
(b) a handle; and
(c) an elongated arm that comprises a conduit that connects the sensor end to the handle;
wherein the conduit houses a link that transmits image information from the image detector through the conduit; and
wherein the conduit further houses at least first and second working channels that extend from the sensor end to the handle;
wherein fluid injected at a handle end of the conduit passes through the first working channel, out the sensor end, and onto the surface under examination; and
wherein the second working channel transmits signals from the ultrasonic sensor array through the conduit.

2. The videoscope of claim 1 further comprising at least one light source positioned at or near the sensor end.

3. The videoscope of claim 2 further comprising at least one optical fiber adapted to transmit light to the at least one light source, wherein the at least one optical fiber is positioned within the arm and extends along the length of the arm.

4. The videoscope of claim 3 wherein the image detecting element is a CCD (charge coupled device), and the at least one transmission path for transmitting signals from the CCD comprises at least one electrical conductor.

5. A videoscope for examining a surface, said videoscope comprising:
(a) a sensor end having an image detector and an eddy current sensor array;
(b) a handle; and
(c) an elongated arm that comprises a conduit that connects the sensor end to the handle;
wherein the conduit houses a link that transmits image information from the image detector through the conduit; and
wherein the conduit further houses at least first and second working channels that extend from the sensor end to the handle;
wherein fluid injected at a handle end of the conduit passes through the first working channel, out the sensor end, and onto the surface under examination; and
wherein the second working channel transmits signals from the eddy current sensor array through the conduit.

6. The videoscope of claim 5 further comprising at least one light source positioned at or near the sensor end.

7. The videoscope of claim 6 further comprising at least one optical fiber adapted to transmit light to the at least one light source, wherein the at least one optical fiber is positioned within the arm and extends along the length of the arm.

8. The videoscope of claim 7 wherein the image detecting element is a CCD (charge coupled device), and the at least one transmission path for transmitting signals from the CCD comprises at least one electrical conductor.

9. A method of using a videoscope comprising:
using the videoscope to identify a portion of an assembly to which fluid is to be applied; and
using the videoscope to deliver and apply fluid to the identified portion;
wherein the sensor is an ultrasonic sensor array or an eddy current sensor array, the fluid delivered is water, and the method further comprises using the ultrasonic sensor array or the eddy current sensor array to examine the portion of the assembly to which fluid was applied.

10. The method of claim 9 wherein the fluid delivered is water or a dye.

11. The method of claim 9 further comprising using the videoscope to place a sensor in contact with the fluid applied to the identified portion of the assembly.

12. The method of claim 9 wherein the fluid is a dye or other marking fluid and the method comprises removing a portion of the assembly limiting access to the marked portion of the assembly, and then using the applied marking fluid to re-identify the marked portion of the assembly.

13. A videoscope for examining a surface of interest, said videoscope comprising:
(a) a sensor end having an image detector and an eddy current sensor that comprises a hemispherical surface and a pickup coil wrapped around the sensor, wherein the hemispherical surface maintains contact with the surface of interest during examination of the surface of interest with the eddy current sensor;
(b) a handle; and
(c) an elongated arm that comprises a conduit that connects the sensor end to the handle;
wherein the conduit houses a link that transmits image information from the image detector through the conduit; and
wherein the conduit further houses at least one working channel that extends from the sensor end to the handle; and
wherein the at least one working channel transmits signals from the eddy current sensor through the conduit.

14. A method for examining a surface of interest, comprising:
(a) providing a videoscope, said videoscope having a sensor end with an image detector and an eddy current sensor that comprises a hemispherical surface and a pickup coil wrapped around the sensor;
(b) maintaining contact between the hemispherical surface and the surface of interest during examination of the surface of interest with the eddy current sensor;
wherein the video scope further comprises a handle, and an elongated arm that comprises a conduit that connects the sensor end to the handle, wherein the conduit houses a link that transmits image information from the image detector through the conduit, and wherein the conduit further houses at least one working channel that extends from the sensor end to the handle; and
wherein the at least one working channel transmits signals from the eddy current sensor through the conduit during examination of the surface with the eddy current sensor.

15. A method for examining a surface of interest, comprising:
(a) providing a videoscope, said videoscope having a sensor end with an image detector and an eddy current sensor;
(b) examining the surface of interest using the image detector in order to identify a portion of the surface that is to be further examined;
(c) further examining, with the eddy current sensor, the portion of the surface identified using the image detector;
wherein the video scope further comprises a handle, and an elongated arm that comprises a conduit that connects the sensor end to the handle, wherein the conduit houses a link that transmits image information from the image detector through the conduit, and wherein the conduit further houses at least one working channel that extends from the sensor end to the handle; and
wherein the at least one working channel transmits signals from the eddy current sensor through the conduit during the further examining of the surface with the eddy current sensor.
